(19) United States
(12) Patent Application Publication
(10) Pub. No.: US 2012/0159493 A1
(43) Pub. Date: Jun. 21, 2012

(54) ADVANCED SEQUENCING GAP MANAGEMENT

(76) Inventor: Stefan Kienzle, St. Leon-Rot (DE)

(21) Appl. No.: 12/969,287

(22) Filed: Dec. 15, 2010

(51) Int. Cl. G06F 9/44

(52) U.S. Cl. 718/102

(57) ABSTRACT

Systems and methods to provide advance sequencing gap management. In example embodiments, a need to generate a proxy gap order for a sequence is detected. Using one or more processors, the proxy gap order is generated based on the detected need. The generated proxy gap order is then inserted into a particular location of the sequence based on the detected need.

### FIELD

The present disclosure relates generally to data management, and in a specific example embodiment, to advanced sequencing gap management.

### BACKGROUND

Many industries use a repetitive manufacturing process to produce their products. The process may include a production or assembly sequence in which a series of orders in the sequence are processed in each assembly station for a certain amount of time. Each order may represent a fixed rate in the sequence, such as one minute. Thus, for example, each minute an assembly line will move from one assembly station to the next.

However, if one or more orders in the sequence needs to be manually deallocated (e.g., due to a production disturbance, quality issues, material shortages), the deallocation may highly impact the assembly process. For example, suppliers provide materials and parts based on the production sequence. If there is a deallocation in one or more orders, the supply chain may be adversely impacted. Furthermore, conventional systems deallocated and reallocated orders manually, which does not allow for optimization of the sequence.

### BRIEF DESCRIPTION OF DRAWINGS

Various ones of the appended drawings merely illustrate example embodiments of the present invention and cannot be considered as limiting its scope.

FIG. 1a-FIG. 1d are a series of sequences which may be used in example embodiments.

FIG. 2 is a block diagram illustrating a sequence management system.

FIG. 3 is a flowchart of an example method to provide sequencing gap management.

FIG. 4 is a flowchart of an example method to reallocate orders to the sequence.

FIG. 5 is a flowchart of an example method to manage distance restriction violations.

FIG. 6 is a flowchart of an example method to manage a sequence having a pilot order.

FIG. 7 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Systems and methods for advanced sequencing gap management are provided. In example embodiments, a need to generate a proxy gap order for a sequence is detected by a deallocation module. The sequence comprises a plurality of orders arranged in series according to constraints or restrictions. The need may be based, for example, on an attribute of one or more orders in the sequence being unavailable, quality issues with a particular order, production disturbances associated with the sequence, a distance restriction violation, or a pilot order.

Using one or more processors, the proxy gap order is generated by a proxy module based on the detected need. The proxy gap order is a placeholder order used to maintain a slot or position in the sequence. In example embodiments, this placeholder order perceives optimized attributes for the slot determined by a sequence optimizer run in the context of a planning situation at the point in time of optimization. In embodiments where an order is deallocated (e.g., removed) from the sequence, the proxy gap order maintains a copy of the attributes of the deallocated order along with a timestamp of the deallocation and an indication of capacity consumption.

The generated proxy gap order is then inserted by the proxy module into a particular location of the sequence based on the detected need. In embodiments where an order is deallocated, the proxy gap order is inserted into the location previously occupied by the deallocated order. In embodiments involving a distance restriction violation, the proxy gap order is positioned in the sequence to alleviate the distance restriction violation. In other embodiments, the proxy gap order may be positioned immediately after a detected pilot order in order to provide more capacity (e.g., time) for handling the pilot order.

In deallocation embodiments, the deallocated order may be reallocated back into the sequence at a later time. For example, if the order is deallocated based on an item associated with an attribute of the order not being available, the availability of the item associated with the attribute will cause the release of the deallocated order for automatic reallocation back into the sequence. A matching algorithm may be performed whereby attributes of the released deallocated orders are compared with attributes of proxy gap orders in the sequence. When attributes match, the deallocated order may be inserted into the position of the matching proxy gap order. In some embodiments, the deallocated order may be shifted to a position after the matching proxy gap order if the matching proxy gap order is in the past. In other embodiments, one or more attributes of the proxy gap orders may be switched to private thus removing the private attribute from consideration by the matching algorithm.

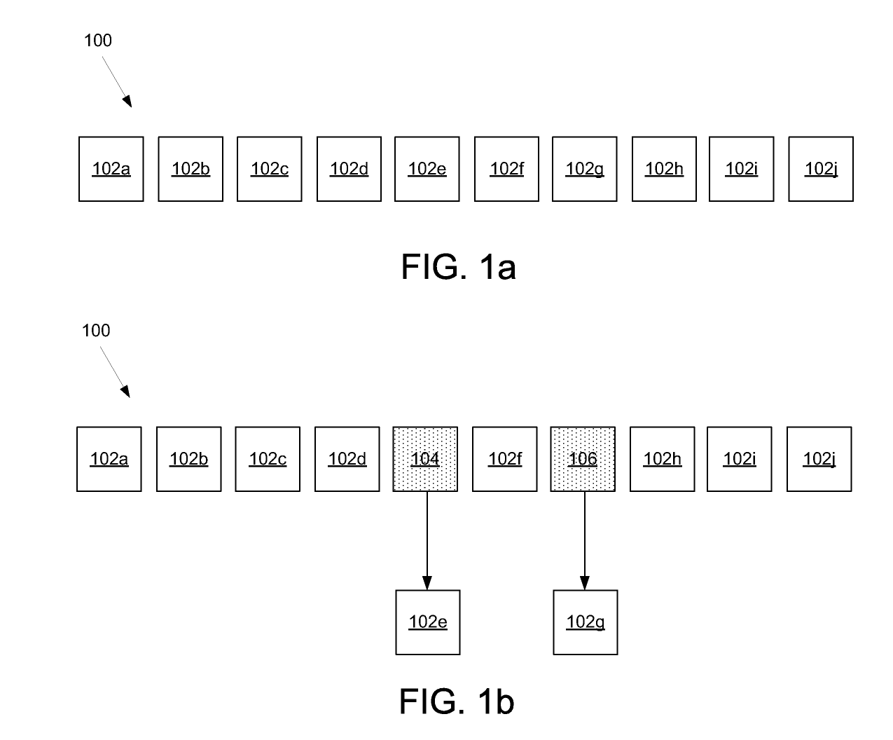

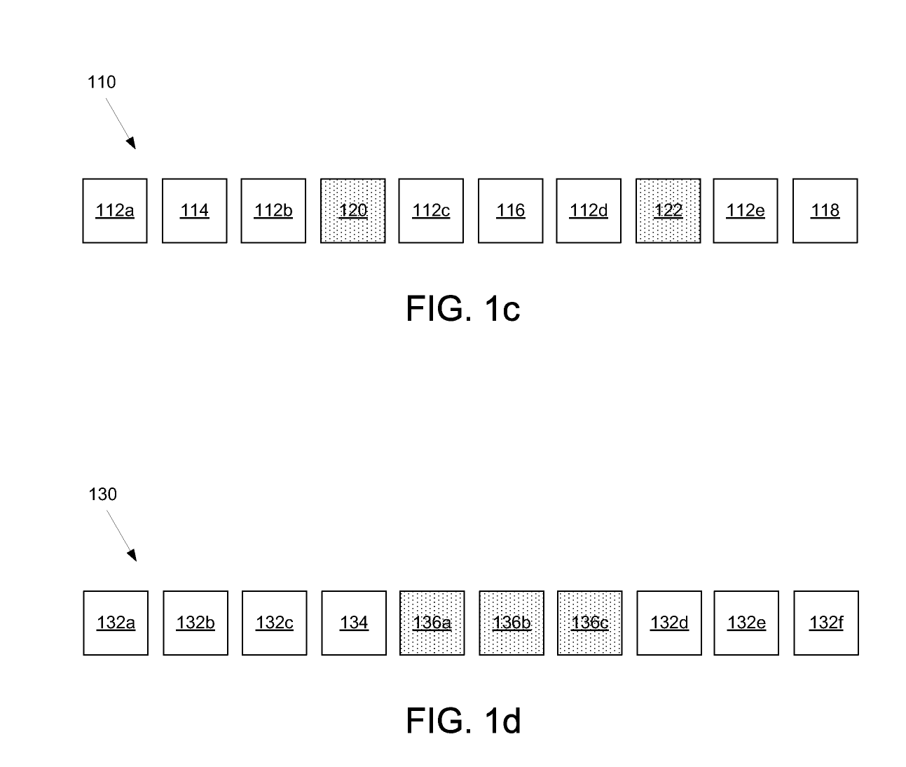

With reference to FIG. 1a, a sequence 100 is shown. The sequence 100 comprises a set of orders 102 organized in series such that the sequence is optimized according to constraints and restrictions associated with processing the sequence. For example, a sequence in a repetitive manufacturing environment is an ordered list of production orders related to a production line. Sequencing can be used to carry out task-based scheduling which determines the sequence in which planned orders are produced on the production line. Sequencing simplifies the dispatching process, especially for high order volumes, and enables a user to display them in a graphic format.

In some embodiments, each order 102 may represent an item or product, and may correspond, for example, to a specific task to be performed within a particular timeframe within each assembly station. The sequence 100 may be optimized based on constraints of an assembly system and on goals of a manufacturer. For example, the sequence 100 may correspond to a vehicle assembly process. Goals may include, for example, customer due dates, avoidance of production bottlenecks, and capacity utilization base for synchronization with supply chain (e.g., just in sequence supply delivery). A model constraint for the car assembly sequence may be that there be an even distribution of complex car models in the sequence 100. For instance, the sequence 100 may have a vehicle with a lot of options (e.g., order 102a), followed by a basic vehicle (e.g., order 102b), followed by a vehicle with few options (e.g., order 102c), which is followed by another vehicle with a lot of options (e.g., order 102d). By spacing the orders with lots of options a particular distance apart, the sequence 100 may flow smoothly and avoid peaks (e.g., assembly time peaks). In another model-to-model example, when producing a series of white vehicle, a constraint may be that every fifth car should be non-white. This constraint will allow individuals checking vehicle color quality to have an opportunity to readjust their eyes. While example embodiments are discussed with reference to a vehicle assembly process, embodiments of the present invention may be utilized in any type of process or system that operates based on orders in a sequence.

During execution of the sequence 100, a problem may occur. For example, the manufacturer may run out of the color red. However, the sequence 100 still includes orders that require the color red. In another example, a certain vehicle has a production issue, which requires the vehicle be taken out of the assembly line. In these situations, the order for the red vehicles or the vehicle with the production issue may be deallocated from the sequence 100.

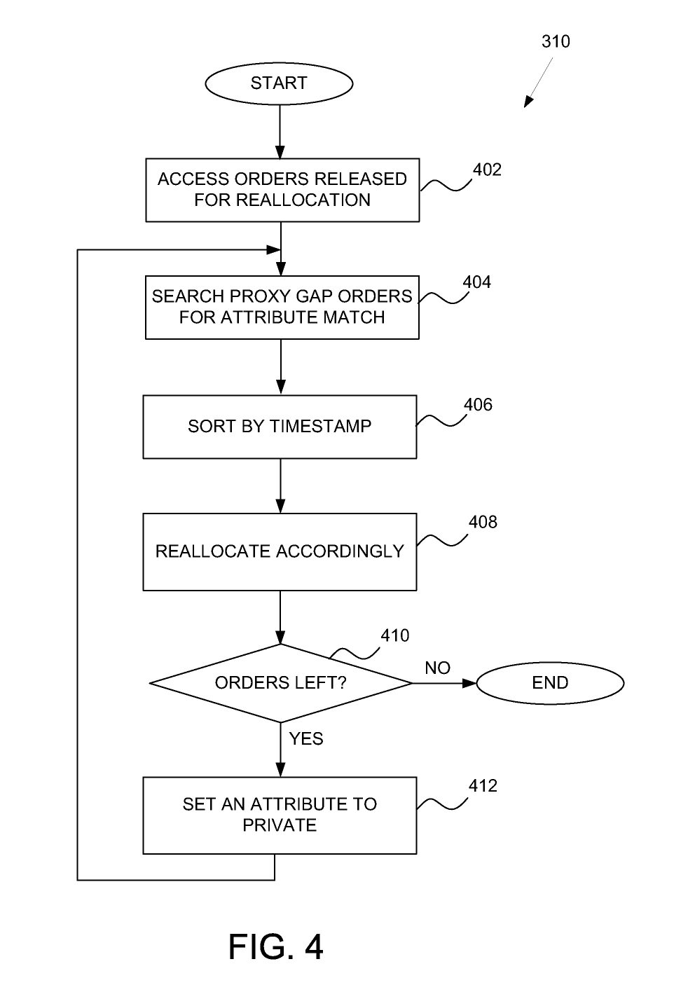

Referring to FIG. 1b, orders 102e and 102g are shown deallocated (e.g., removed) from the sequence 100. In the place of the orders 102e and 102g, proxy gap orders 104 and 106 are generated and inserted. The proxy gap orders 104 and 106 are placeholder orders that indicate where the deallocated orders 102e and 102g were previously positioned. The proxy gap orders 104 and 106 may allow for capacity (e.g., time) to be consumed in the place of a deallocated order. The proxy gap orders 104 and 106 also maintain information associated with the deallocated orders 102e and 102g such that if the deallocated orders 102e and 102g are, at a later time, to be reallocated back into the sequence 100, the proxy gap orders 104 and 106 may be used for matching purposes as will be discussed in more detail in connection with FIG. 4. The information maintained within the proxy gap orders 104 and 106 may include attributes of the deallocated orders 102e and 102g. For example, attributes of the deallocated order 102e may include (1) color red, (2) has a sunroof, and (3) has xenon headlights. In some embodiments, all attributes of the deallocated orders 102e are maintained in the proxy gap order 104. In other embodiments, only some of the attributes are maintained in the proxy gap order 104. For example, highest priority attributes (e.g., red, sunroof, xenon headlights) are maintained, while lower priority attributes (e.g., CD changer, spoke hubcaps, or other items which may be easily changeable) may not be maintained. The proxy gap order may also contain a time stamp associated with the deallocaton of the order and creation of the corresponding proxy gap order and an indication of whether the proxy gap order consumes capacity (e.g., consumes time in the sequence).

Proxy gap orders may be used in other embodiments to prevent violations of hard restrictions in a sequence. Referring now to FIG. 1c, a distance restriction may require that between any two orders with attribute “blue” (i.e., orders 112a-112e) of a sequence 110 there be a minimum distance of one order. In FIG. 1c, orders without attribute “blue” include order 114, order 116, and order 118. However, there are no orders between attribute “blue” orders 112b and 112c and between attribute “blue” orders 112d and 112e. Thus, proxy gap orders 120 and 122 are generated and inserted into the sequence 110 between orders 112b and 112c and between orders 112d and 112e. As such, the proxy gap order consumes a capacity between, for example, the orders 112d and 112e in order to prevent a restriction violation. By using the proxy gap orders 120 and 122, in this example, the original sequence 110 may be kept stable while avoiding any hard restriction violations.

In another embodiment, proxy gap orders may be used to alleviate work load issues. For example, a sequence 130 may contain a pilot order 134 (e.g., an order for a tentative model or sample), which will take more time to assemble, along with other orders 132a-132f. In this example, each order may be scheduled for a one minute process in each assembly station. However, the pilot order 134 may require four minutes in each assembly station. Thus, proxy gap orders 136a-136c may be automatically generated with a default value (i.e., 1 minute) to accommodate the pilot order 134. Each of the proxy gap orders 136a-136c consumes capacity (e.g., time) and occupy a task or slot in the sequence 130 in order to provide more precise scheduling to the corresponding manufacturing process.

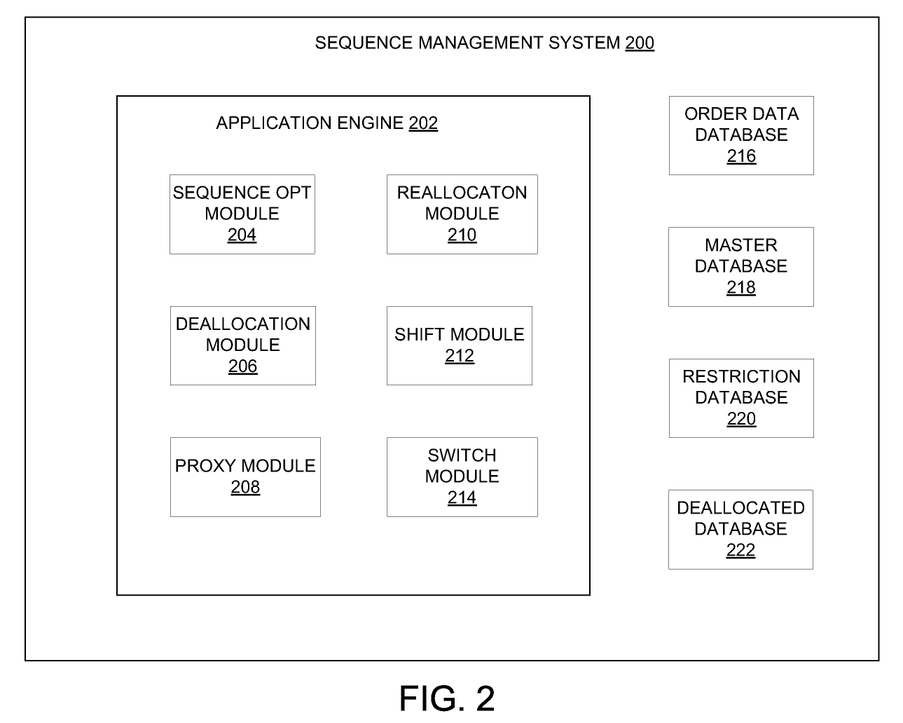

Referring to FIG. 2, a sequence management system 200 is shown. The sequence management system 200 generates optimized sequences and handles gaps in the optimized sequences. The sequence management system 200 comprises an application engine 202 which includes a plurality of modules communicatively coupled together for optimizing sequences and managing gaps in the optimized sequences. In example embodiments, the application engine 202 comprises a sequence optimization module 204, a deallocation module 206, a proxy module 208, a reallocation module 210, a shift module 212, and a switch module 214. The sequence management system 200 further comprises (or is coupled to) a plurality of databases that provide data for generating sequences and store data resulting from sequence optimization and gap management. The databases include an order data database 216, a master database 218, a restriction database 220, and a deallocated database 222.

In operation, the sequence optimization module 204 generates a master sequence. The master sequence is a sequence that is provided, for example, to an assembly system for manufacturing guidance as well as being provided to supplies in order to schedule just in time or just in sequence supply delivery. The sequence optimization module 204 accesses the order data database 216 and selects order data (e.g., orders to be organized into a sequence). Then, tasks associated with the orders are scheduled based on task times stored in the master database 216. In example embodiments, the tasks are scheduled according to a fixed pattern (e.g., one minute per task). Next, the sequence optimization module 204 optimizes the selection by accessing appropriate restrictions and constraints (e.g., no more than 4 white car orders in a row, even distribution of high option cars) from the restriction database 220 and applying the restrictions and constraints to the selection. The result is a sequence that is posted into the order data database 218. It should be noted that, in some embodiments, the sequence optimization module 204 may be located separate from the other components of the application engine 202 (e.g., in a different system or device).

The deallocation module 206 manages the deallocation of orders from a sequence. In example embodiments, the deallocation module 206 detects a need to deallocate an order. For example, red paint may no longer be available. In response, a trigger may be activated indicating that color red is not available. The trigger may be received by the deallocation module 206. The deallocation module 206 then determines whether any (future) orders in the sequence contain the attribute “red.” These orders may then be deallocated from the sequence by the deallocation module 206.

The proxy module 208 generates one proxy gap order for each deallocated order and inserts the proxy gap order into the sequence. In example embodiments, the proxy module 208 accesses attributes of a deallocated order and copies those attributes to the proxy gap order. The proxy gap order may also include a timestamp indicating when the corresponding order was deallocated and an indication of whether the proxy gap order consumes capacity (e.g., time). The proxy gap order is then positioned in the sequence where the corresponding deallocated order was originally positioned, thus replacing the deallocated order.

The reallocation module 210 reallocates orders that have been previously deallocated. The reallocation module 210 determines previously deallocated orders that are ready to be reallocated and performs an attribute matching algorithm against the proxy gap orders in the sequence for matching relevant attributes with those of the deallocated orders. Matching proxy gap orders may be replaced by the corresponding deallocated orders by the reallocation module 210. The reallocation process will be discussed in more detail in connection with FIG. 4 below.

The shift module 212 works in connection with the reallocation module 210 to reallocate a deallocated order into a future part of a sequence (e.g., a portion of the sequence occurring after the present time). For example and referring to FIG. 1b, the order 102g is to be reallocated into the slot currently being occupied by the proxy gap order 106. However, the assembly system is presently performing operations of order 102h, the shift module 212 determines a location to reallocate the deallocated order that is in a future position in the sequence (e.g., after order 102h).

The switch module 214 may switch off an attribute in an order. In example embodiments, an attribute may be switched between public and private settings. Public-set attributes are taken into account when the sequence optimization module generates the sequence and when the allocation module 210 runs the attribute matching algorithm to reallocate deallocated orders. A private setting on an attribute will “hide” the attribute from the processes performed by the sequence optimization module 204 or the allocation module 210. The private-set attribute is not removed from the order, just hidden and ignored for purposes of sequencing restrictions.

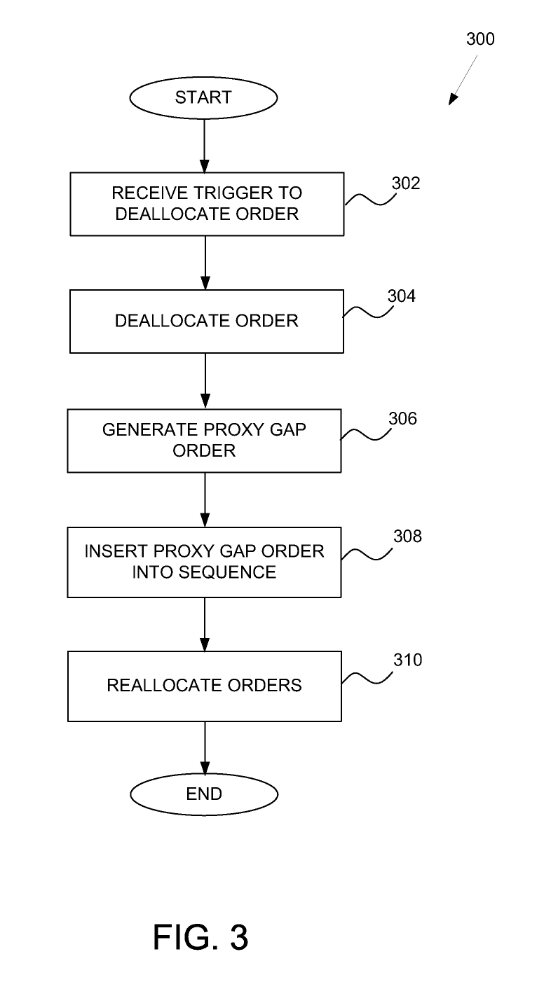

FIG. 3 is a flowchart of an example method 300 to provide sequencing gap management. In operation 302, a trigger to deallocate an order from a sequence is received by the deallocation module 206. The trigger may be manually created (e.g., a worker may determine that a part is no longer available and provide the trigger) or be automatically generated (e.g., a machine detects it is out of a part and provides the trigger). The trigger may indicate one or more affected attributes (e.g., color “red” when red paint is not available) that require the deallocation of the order.

In operation 304, one or more orders that contain the affected attribute is determined. For example, the deallocation module 206 analyzes the sequence and determines whether any future orders in the sequence contain the attribute “red.” These orders may then be deallocated from the sequence by the deallocation module 206.

A proxy gap order is generated for each deallocated order in operation 306. In example embodiments, the proxy module 208 accesses attributes of a deallocated order and copies those attributes to the proxy gap order. Other information such as a timestamp associated with the deallocation or an indication of whether the proxy gap order consumes capacity may also be stored in the proxy gap order. The proxy gap order is then positioned in the sequence where the corresponding deallocated order was originally located in operation 308.

Once the issue has been resolved with respect to the affected attribute (e.g., red paint becomes available), the deallocated orders having the affected attribute may be reallocated in operation 310. In some embodiments, the deallocated order may be returned to its original position in the sequence and replace the proxy gap order in that position. In other embodiments, reallocation may involve shifting the order or the use of attribute switches where some attributes may be switched to “private” and are not considered when performing the attribute matching algorithm. This reallocation process will be discussed in more detail in connection with FIG. 4.

FIG. 4 is a flowchart of an example method (operation 310) to reallocate deallocated orders to the sequence. This example method is applicable with the attribute switching option whereby attributes may be set temporary to “private” for a duration of the automatic reallocation algorithm performed by the reallocation module 210. In operation 402, deallocated orders released for reallocation are accessed. Referring back to the car sequence example, red paint may become available again. As such, any deallocated orders that were deallocated based on the lack of red paint are released for automatic reallocation. In example embodiments, the reallocation module 210 may release these deallocated orders.

In operation 404, proxy gap orders are searched for attribute matches. In example embodiments, all attributes that are public in a deallocated order should match the attributes in the proxy gap order.

Once matches are found, then the deallocated orders are sorted in connection with the matching proxy gap orders based on a deallocated timestamp of the deallocated order in operation 406. In example embodiments, the reallocation module 210 sorts the deallocated orders to minimize a distance between a new time slot in the sequence (of the matching proxy gap order) to the original time stamp of the deallocated order. For example and referring to FIG. 1b, the deallocated order 102e would be sorted such that it will be positioned in a time slot corresponding to a matching proxy gap order prior to the deallocated order 102g.

In operation 408, each matched deallocated order then replaces its corresponding proxy gap order as determined by operations 404 and 406. As such, the reallocation module 210 removes the corresponding proxy gap order and inserts the matching deallocated order into the corresponding time slot in the sequence.

In operation 410, a determination is made as to whether any deallocated orders that have been released for automatic allocation remain. Any such remaining deallocated orders will include at least one attribute (of its set of attributes) that prevents the deallocated order from finding a matching proxy gap order. In one embodiment, one of the attributes (e.g., one of the at least one attribute that prevents a match) is switched to “private” thus removing the attribute as a sequence restriction. This switch may be performed automatically by the switch module 214 on the proxy gap orders, the deallocated orders, or a combination of both. In an alternative embodiment, an attribute that has statistically the highest frequency of occurrence within the proxy gap orders may be switched to private. The process then returns to operation 404. It is noted that operations 404-412 may be performed iteratively whereby a different attribute (e.g., in descending order of occurrence, priority, or listing) may be set private for a deallocated order in operation 412 until all deallocated orders are reallocated.

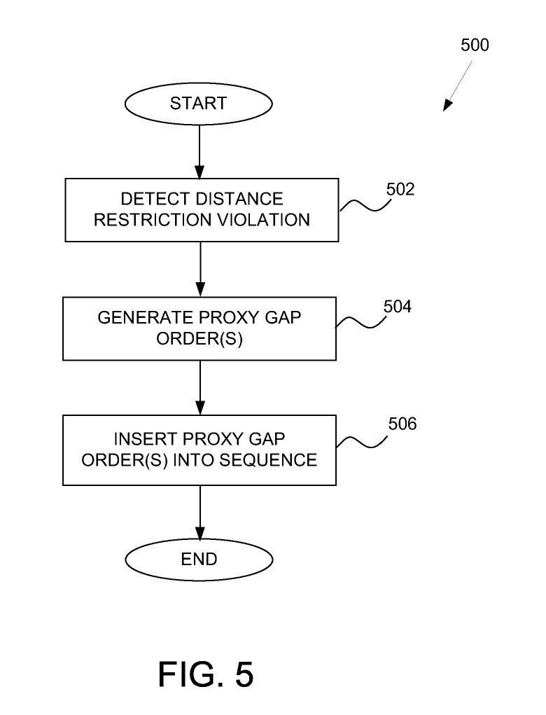

FIG. 5 is a flowchart of an example method 500 to manage distance restriction violations. A distance restriction requires orders with a particular attribute to be spaced a minimum distance apart. For example, a distance restriction may require that between any two orders with attribute “blue” in a sequence 110 there be a minimum distance of one order. In operation 502, a distance restriction violation may be detected in a master sequence. In one embodiment, the proxy module 208 detects the violation.

Based on the detection, the proxy module 208 generates one or more proxy gap orders in operation 504. Because these proxy gap orders are not based on a deallocated order, these proxy gap orders may contain little or no attributes. However, the proxy gap order may contain an indication of whether the proxy gap order consumes capacity.

In operation 506, the generated proxy gap orders are inserted into slots of the sequence to prevent the distance restriction violation. By using the proxy gap orders, the original sequence may be kept stable while avoiding the distance restriction violation.

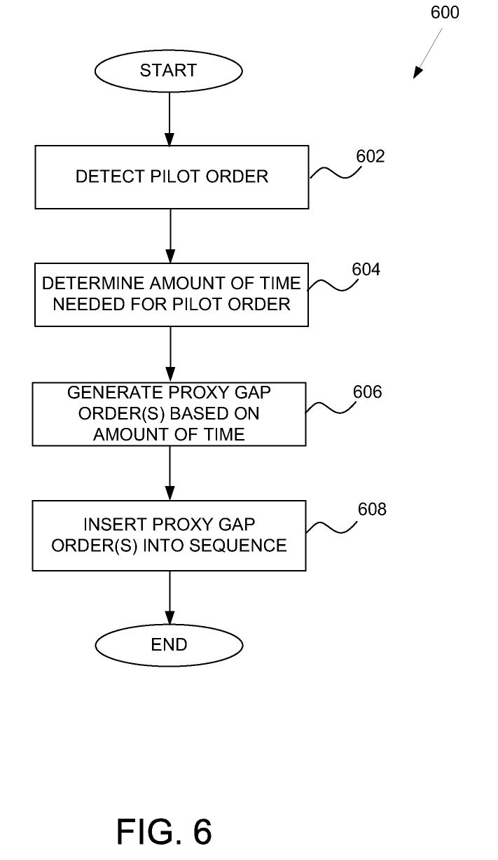

FIG. 6 is a flowchart of an example method 600 to manage a sequence having a pilot order. The pilot order may require more time to assemble since it is typically new or non-standard. For example, each order in the sequence may be scheduled for a one minute process in each assembly station. However, the pilot order may require four minutes in each assembly station. Thus, proxy gap orders may be used to alleviate work load issues in a pilot series sequence. In operation 602, a pilot order is detected. In one embodiment, the proxy module 208 detects the pilot order.

In operation 604, the proxy module 208 determines an amount of time needed for the pilot order. The determination may be based on data regarding the pilot order that is stored, for example, in the order data database 216 or task times stored in the master database 218.

In operation 606, one or more proxy gap orders are generated based on the amount of time determined in operation 604. Continuing with the example, since the pilot order needs four minutes in each assembly station, three proxy gap orders are generated to accommodate the pilot order 134. Each of the proxy gap orders consumes capacity (e.g., one minute) and occupies a task or slot in the sequence.

The generated proxy gap orders are then inserted into the sequence in operation 608. In example embodiments, the proxy module 208 inserts the proxy gap orders immediately after the pilot order.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

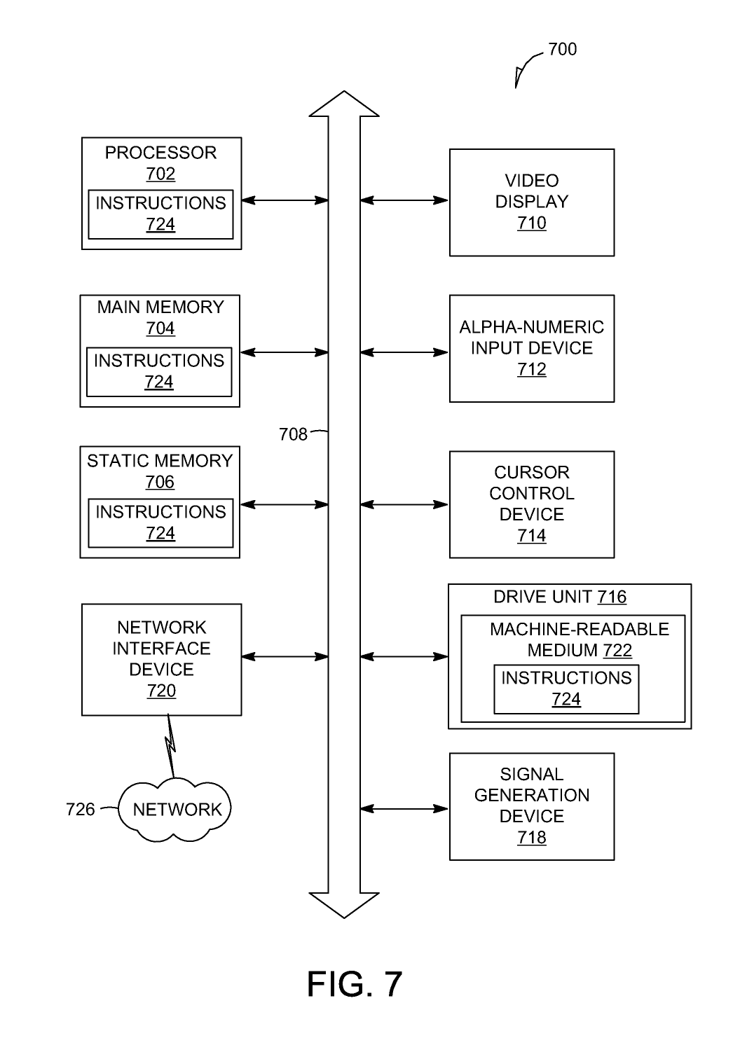

With reference to FIG. 7, an example embodiment extends to a machine in the example form of a computer system 700 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, a server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 may include a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). In example embodiments, the computer system 700 also includes one or more of an alpha-numeric input device 712 (e.g., a keyboard), a user interface (UI) navigation device or cursor control device 714 (e.g., a mouse), a disk drive unit 716, a signal generation device 718 (e.g., a speaker), and a network interface device 720.

The disk drive unit 716 includes a machine-readable storage medium 722 on which is stored one or more sets of instructions 724 and data structures (e.g., software instructions) embodying or used by any one or more of the methodologies or functions described herein. The instructions 724 may also reside, completely or at least partially, within the main memory 704 or within the processor 702 during execution thereof by the computer system 700, the main memory 704 and the processor 702 also constituting machine-readable media.

While the machine-readable storage medium 722 is shown in an exemplary embodiment to be a single medium, the term “machine-readable storage medium” may include a single storage medium or multiple media (e.g., a centralized or distributed database, or associated caches and servers) that store the one or more instructions. The term “machine-readable storage medium” shall also be taken to include any tangible medium that is capable of storing, encoding, or carrying instructions for execution by the machine and that causes the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 724 may further be transmitted or received over a communications network 726 using a transmission medium via the network interface device 720 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific exemplary embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As used herein, the term “or” may be construed in either an inclusive or exclusive sense. Additionally, although various example embodiments discussed focus on a specific network-based environment, the embodiments are given merely for clarity in disclosure. Thus, any type of electronic system, including various system architectures, may employ various embodiments of the search system described herein and is considered as being within a scope of example embodiments.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
detecting a need to generate a proxy gap order for a sequence, the sequence comprising a plurality of orders arranged in series;
automatically generating, using one or more processors, the proxy gap order based on the detected need; and
inserting the proxy gap order into a particular location of the sequence based on the detected need.

2. The method of claim 1, wherein detecting the need comprises receiving a trigger to deallocate an order from the sequence.

3. The method of claim 2, wherein the trigger to deallocate is based on an attribute of the order being unavailable.

4. The method of claim 2, further comprising deallocating the order from the sequence, wherein the inserting comprises inserting the proxy gap order into a location previously occupied by the deallocated order.

5. The method of claim 4, further comprising reallocating the deallocated order by matching attributes of the deallocated order with attributes of proxy gap orders in the sequence.

6. The method of claim 5, further comprising shifting the deallocated order into a position after a proxy gap order having matching attributes based on the proxy gap order having the matching attributed occurring in the past.

7. The method of claim 5, further comprising switching at least one attribute of the proxy gap orders in the sequence to a private setting, the private setting removing the at least one attribute from a matching algorithm used to match the attributes.

8. The method of claim 2, wherein the automatically generating comprises:
copying attributes from the order;
including a timestamp associated with a deallocation of the order; and
indicating whether the proxy gap order consumes capacity.

9. The method of claim 1, wherein the detecting comprises detecting a distance restriction violation, and wherein the generating comprises generating at least one proxy gap order to alleviate the distance restriction violation.

10. The method of claim 1, wherein the detecting comprises detecting a pilot order, and wherein the generating comprises generating at least one proxy gap order to accommodate a capacity requirement of the pilot order.

11. A system comprising:
a deallocation module configured to detect a need to generate a proxy gap order for a sequence; and
a proxy module
configured to automatically generate, using one or more processors, the proxy gap order based on the detected need, and
configured to insert the proxy gap order into a particular location of the sequence based on the detected need.

12. The system of claim 11, wherein the deallocation module is further configured to deallocate an order from the sequence, and wherein the proxy module inserts the proxy gap order into a location previously occupied by the deallocated order.

13. The system of claim 12, further comprising a reallocation module configured to reallocate the deallocated order by matching attributes of the deallocated order with attributes of proxy gap orders in the sequence.

14. The system of claim 13, further comprising a shift module configured to shift the deallocated order into a position after a proxy gap order having matching attributes based on the proxy gap order having the matching attributed occurring in the past.

15. The system of claim 13, further comprising a switch module configured to switch at least one attribute of the proxy gap orders in the sequence to a private setting, the private setting removing the at least one attribute from a matching algorithm used to match the attributes.

16. A non-transitory machine-readable storage medium in communication with at least one processor, the machine-readable storage medium storing instructions which, when executed by the at least one processor, provides a method comprising:
detecting a need to generate a proxy gap order for a sequence;
automatically generating, using one or more processors, the proxy gap order based on the detected need; and
inserting the proxy gap order into a particular location of the sequence based on the detected need.

17. The non-transitory machine-readable storage medium of claim 16, wherein the method further comprises deallocating an order from the sequence, and wherein the inserting comprises inserting the proxy gap order into a location previously occupied by the deallocated order.

18. The non-transitory machine-readable storage medium of claim 17, wherein the method further comprises reallocating the deallocated order by matching attributes of the deallocated order with attributes of proxy gap orders in the sequence.

19. The non-transitory machine-readable storage medium of claim 18, wherein the method further comprises shifting the deallocated order into a position after a proxy gap order having matching attributes based on the proxy gap order having the matching attributed occurring in the past.

20. The non-transitory machine-readable storage medium of claim 18, wherein the method further comprises switching at least one attribute of the proxy gap orders in the sequence to a private setting, the private setting removing the at least one attribute from a matching algorithm used to match the attributes.
